(19) United States
(12) Patent Application Publication
(10) Pub. No.: US 2017/0256843 A1
(43) Pub. Date: Sep. 7, 2017

(54) RECONFIGURABLE CASING ANTENNA SYSTEM

(71) Applicant: Smart Antenna Technologies Ltd., Bimingham (GB)

(72) Inventors: Sampson Hu, Birmingham (GB); Zhengpeng Wang, Birmingham (GB); Xiang Gao, Birmingham (GB)

(21) Appl. No.: 15/508,797

(22) PCT Filed: Sep. 4, 2015
(86) PCT No.: PCT/GB2015/052551

§ 371 Date: Mar. 3, 2017

(30) Foreign Application Priority Data
Sep. 5, 2014 (GB) 1415781.2

(51) Int. Cl. H01Q 1/24; H01Q 9/26; H01Q 5/335; H01Q 21/00; H01Q 21/28; H01Q 1/48

(52) U.S. Cl. CPC H01Q 1/243; H01Q 21/28; H01Q 1/48; H01Q 5/335; H01Q 21/005; H01Q 21/0068; H01Q 9/26

(57) ABSTRACT

There is disclosed a reconfigurable antenna device comprising a plurality of antennas disposed about a periphery of a substantially rectangular shape having top, bottom, left and right sides. The antenna device includes a first balanced antenna having first and second radiating arms each having a proximal portion and a distal portion, proximal portions extending along the top side in respectively opposed directions from a substantially central feed point, and the distal portions extending part way down the left and right sides. The antenna device further includes a first unbalanced antenna located generally between the distal portions and adjacent to the proximal portions of the first and second radiating arms. In addition, the antenna device includes a second balanced antenna having a first radiating arm extending up the left side from a feed peed point in a bottom left corner of the periphery and a second radiating arm extending along the bottom side from the feed point in the bottom left corner of the periphery, and a third balanced antenna having a first radiating arm extending up the right side from a feed point in a bottom right corner of the periphery and a second radiating arm extending along the bottom side from the feed point in the bottom right corner of the periphery.

This invention relates to a reconfigurable antenna. Particularly, but not exclusively, the invention relates to a reconfigurable multiple-input multiple-output (MIMO) casing antenna for use in a portable electronic device such as a mobile phone handset.

### BACKGROUND

Multiple-input multiple-output (MIMO) wireless systems exploiting multiple antennas as both transmitters and receivers have attracted increasing interest due to their potential for increased capacity in rich multipath environments. Such systems can be used to enable enhanced communication performance (i.e. improved signal quality and reliability) by use of multi-path propagation without additional spectrum requirements. This has been a well-known and well-used solution to achieve high data rate communications in relation to 2G and 3G communication standards. For indoor wireless applications such as router devices, external dipole and monopole antennas are widely used. In this instance, high-gain, omni-directional dipole arrays and collinear antennas are most popular. However, very few portable devices with MIMO capability are available in the marketplace. The main reason for this is that, when gathering several radiators in a portable device, the small allocated space for the antenna limits the ability to provide adequate isolation between each radiator.

A reconfigurable MIMO antenna is known from WO 2012/072969 (the content of which is incorporated into the present disclosure by reference). An embodiment is described in which the antenna comprises a balanced antenna located at a first end of a PCB and a two-port chassis-antenna located at an opposite second end of the PCB. However, in certain applications this configuration may not be ideal or even practical since it requires two separate areas in which to locate each antenna. However, as mentioned above this spacing was chosen to provide adequate isolation between each antenna structure.

Another reconfigurable antenna is known from WO 2014/020302 (the content of which is incorporated into the present disclosure by reference). This antenna comprises a balanced antenna and an unbalanced antenna mounted on a supporting PCB substrate, with both the balanced antenna and the unbalanced antenna located at the same end of the substrate. The antenna may be configured as a chassis antenna for use in a portable device and may be configured for MIMO applications. In one embodiment of the antenna of WO 2014/020302, there is provided a floating groundplane connected to the balanced antenna. The floating groundplane is constituted by a rectangular metal patch located on a first surface of the substrate, centrally below feed lines provided on the first surface to feed the balanced and unbalanced antennas. A first matching circuit configured to excite the arms of the balanced antenna is located on the floating groundplane. The unbalanced antenna is mounted on a second surface of the substrate, opposed to the first surface, and is connected to a second matching circuit mounted on the PCB substrate. In another embodiment, the floating groundplane may be incorporated in one arm of the balanced antenna, thereby saving space on the PCB substrate. Each matching circuit is coupled to a signal port, and the antenna as disclosed therefore provides only two ports.

Certain handset and other portable device manufacturers, however, require an antenna that is incorporated into a peripheral portion of a mobile handset, for example incorporated into the casing of the handset around edge regions thereof. The antenna may be formed as a metallic bezel for a screen of a mobile handset. Such antennas are commonly known as frame antennas. An example of such a frame antenna is disclosed in U.S. Pat. No. 8,270,914. While such frame antennas have certain advantages, for example a relatively large size, they can be particularly susceptible to performance losses due to contact with a user's hand when holding the handset. These problems can be reduced by providing exposed conductive parts of the frame antenna with a dielectric coating and by using appropriate antenna design techniques.

While known frame antennas have been found to be effective, there is still room for improvement, especially in the area of multi-band operation.

### BRIEF SUMMARY OF THE DISCLOSURE

Viewed from a first aspect, there is provided a reconfigurable antenna device comprising a plurality of antennas disposed about a periphery of a substantially rectangular shape having top, bottom, left and right sides, the antennas comprising:

i) a first balanced antenna having first and second radiating arms each having a proximal portion and a distal portion, proximal portions extending along the top side in respectively opposed directions from a substantially central feed point, and the distal portions extending part way down the left and right sides;

ii) a first unbalanced antenna located generally between the distal portions and adjacent to the proximal portions of the first and second radiating arms;

iii) a second balanced antenna having a first radiating arm extending up the left side from a feed peed point in a bottom left corner of the periphery and a second radiating arm extending along the bottom side from the feed point in the bottom left corner of the periphery; and

iv) a third balanced antenna having a first radiating arm extending up the right side from a feed point in a bottom right corner of the periphery and a second radiating arm extending along the bottom side from the feed point in the bottom right corner of the periphery.

In the context of the present application, a “balanced antenna” is an antenna that has a pair of radiating arms extending in different, for example opposed or orthogonal, directions away from a central feed point. Examples of balanced antennas include dipole antennas and loop antennas. In a balanced antenna, the radiating arms are fed against each other, and not against a groundplane. In many balanced antennas, the two radiating arms are substantially symmetrical with respect to each other, although some balanced antennas may have one arm that is longer, wider or otherwise differently configured to the other arm. A balanced antenna is usually fed by way of a balanced feed.

In contrast, an “unbalanced antenna” is an antenna that is fed against a groundplane, which serves as a counterpoise. An unbalanced antenna may take the form of a monopole antenna fed at one end, or may be configured as a centre fed monopole or otherwise. An unbalanced antenna may be configured as a chassis antenna, in which the antenna generates currents in the chassis of the device to which the antenna is attached, typically a groundplane of the device. The currents generated in the chassis or groundplane give rise to radiation patterns that participate in the transmission/reception of RF signals. An unbalanced antenna is usually fed by way of an unbalanced feed.

A balun may be used to convert a balanced feed to an unbalanced feed and vice versa.

A reconfigurable antenna is an antenna capable of modifying dynamically its frequency and radiation properties in a controlled and reversible manner. In order to provide a dynamical response, reconfigurable antennas integrate an inner mechanism (such as RF switches, varactors, mechanical actuators or tuneable materials) that enable the intentional redistribution of the RF currents over the antenna surface and produce reversible modifications over its properties. Reconfigurable antennas differ from smart antennas because the reconfiguration mechanism lies inside the antenna rather than in an external beamforming network. The reconfiguration capability of reconfigurable antennas is used to maximize the antenna performance in a changing scenario or to satisfy changing operating requirements.

The second and third balanced antennas, by virtue of their configuration with respective first arms extending along respective right and left sides of the periphery towards the first balanced antenna and the first unbalanced antenna, and respective second arms extending towards each other along the bottom side of the periphery, will generate respective radiation patterns that are substantially orthogonal to each other. In certain embodiments, the first and second arms are arranged substantially at right angles to each other in each of the second and third balanced antennas. Because the second and third balanced antennas generate substantially orthogonal radiation patterns, they will be well isolated from each other during operation, with excellent isolation when operating at different frequencies, and reasonable isolation when operating at substantially the same frequency. Moreover, the radiation patterns generated by the second and third balanced antennas will be oriented at substantially 45 degrees to the mutually orthogonal radiation patterns generated by the first balanced and first unbalanced antennas at the top end of the periphery. In this way, the second and third balanced antennas will be as well isolated from the first balanced and first unbalanced antennas as is possible within the constraints of the real estate available in a portable device such as a mobile handset or tablet or laptop.

In addition, there may be provided a second unbalanced antenna located on the left side between the distal portion of the first radiating arm of the first balanced antenna and the first radiating arm of the second balanced antenna, the second unbalanced antenna having a feed point.

Furthermore, there may be provided a third unbalanced antenna located on the right side between the distal portion of the second radiating arm of the first balanced antenna and the first radiating arm of the third balanced antenna, the third unbalanced antenna having a feed point.

In certain embodiments, the second and third unbalanced antennas are together configured as a pair of chassis antennas.

The proximal and distal portions of each radiating arm of the first balanced antenna may be disposed substantially at right angles to each other. Likewise, the first and second radiating arms of each of the second and third balanced antennas may be disposed substantially at right angles to each other.

Instead of the third and/or fourth unbalanced antennas, or in addition thereto, there may be provided a fourth unbalanced antenna generally adjacent and parallel to the proximal portion of the first radiating arm of the first balanced antenna, and a fifth unbalanced antenna generally adjacent and parallel to the proximal portion of the second radiating arm of the first balanced antenna. The fourth and fifth unbalanced antennas are each provided with a feed point.

The antenna device may be configured as a part of a casing of a mobile phone handset. The conductive antenna elements that are exposed and liable to come into contact with a user's hand may be provided with a dielectric coating. The antenna device may also be configured as part of a casing of a tablet or laptop computer.

For certain high-end mobile handsets having a metal casing, it may be desirable to provide slots or gaps in the metal casing. It is envisaged that the metal casing with the slots may assist the radiating performance of casing antenna of certain embodiments.

The antenna device may further comprise a substrate, which may comprise a printed circuit board substrate. A conductive groundplane may be provided in the form of a conductive layer on one surface of the substrate or disposed between upper and lower surfaces of the substrate.

The antennas may take the form of elongate conductive metal strips that are arranged around the periphery.

In some embodiments, the strips each have a width that is disposed substantially perpendicular to the plane of the substrate.

In other embodiments, the first unbalanced antenna may comprise an elongate metal strip that may be disposed in the same plane as or parallel to the substrate at a top edge thereof, adjacent to the proximal portions of the radiating arms of the first balanced antenna and between the distal portions of the radiating arms.

The feed points of the various antennas may each be connected via a matching circuit to a signal port. The matching circuits and signal ports may be provided on the substrate.

Where the first unbalanced antenna is mounted flat on a surface of the top edge of the substrate, this part of the substrate is preferably free of the conductive groundplane. In this embodiment, a floating groundplane in the form of a conductive patch may be provided over or under a central portion of the first unbalanced antenna, and a matching circuit for the first balanced antenna may be located on the floating groundplane. This can save valuable real estate on the substrate.

The first, second and/or third balanced antennas may be configured as dipole antennas. In some embodiments, the first, second and/or third balanced antennas may be configured as centre feed slot antennas.

The first, second, third, fourth and/or fifth unbalanced antennas may be configured as offset feed slot antennas.

The antennas are not in conductive electrical contact with each other, and ends of the radiating arms of the antennas may be spaced from each other by an air gap or a solid dielectric spacer element.

Some or all of the antennas may be wholly or partially covered with a dielectric coating. This can help to reduce detuning when contacted by a user's hand or other external influences.

Preferred embodiments thus provide a reconfigurable antenna which can be located around a periphery of a mobile phone handset or tablet, and which is therefore easily integrated into small portable devices. The antenna device may have a small, low profile and be relatively cheap to manufacture. Embodiments may offer good performance (high efficiency and gain), reduced specific absorption rate (SAR), a wide bandwidth or range of bandwidths and high isolation between each radiator.

Matching circuitry may be provided for each antenna element to tune the respective element to a desired operating frequency or band. For example, the antenna device may be configured to cover one or more of: DVB-H, GSM710, GSM850, GSM900, GSM1800, PCS1900, GPS1575, UMTS2100, WiFi (e.g. 2.4 GHz and 5 GHz), Bluetooth®, LTE, LTA and 4G frequency bands.

Multiple matching circuits may be provided for the various antenna elements, and different modes of operation may be selected by switching between the various matching circuits.

Each matching circuit may comprise at least one variable capacitor to tune the frequency of its associated antenna element over a desired frequency range. The variable capacitor may be constituted by multiple fixed capacitors with switches, or by varactors or

MEMs capacitors. In addition, one or more of the matching circuits may further be provided with at least one inductor, which may be fixed or variable.

The first balanced antenna and its associated matching circuitry may be coupled to a first signal port.

The first unbalanced antenna and its associated matching circuitry may be coupled to a second signal port.

The second balanced antenna and its associated matching circuitry may be coupled to a third signal port.

The third balanced antenna and its associated matching circuitry may be coupled to a fourth signal port.

The second unbalanced antenna (where provided) and its associated matching circuitry may be coupled to a fifth signal port.

The third unbalanced antenna (where provided) and its associated matching circuitry may be coupled to a sixth signal port.

The fourth unbalanced antenna (where provided) and its associated matching circuitry may be coupled to a seventh signal port.

The fifth unbalanced antenna (where provided) and its associated matching circuitry may be coupled to an eighth signal port.

Moreover, using the splitter circuits and matching circuits disclosed in WO 2013/014458 (the content of which is incorporated into the present disclosure by reference), it is possible for each of the first to fifth unbalanced antennas to drive two signal ports, the signals at each pair of signal ports being tuneable independently of each other.

Accordingly, an antenna device as disclosed herein may be configured with 4, 5, 6, 7, 8, 9, 10, 11, 12, 13, 14, 15 or 16 ports, each port being independently tuneable.

Alternatively or in addition, using the multi-band configurations disclosed in the present Applicant's co-pending UK patent application no GB1415780.4 filed simultaneously with the present application, it is possible for each signal port to support two or more independently tuneable signals.

As such, a single, small antenna device with a relatively small footprint can be used to support operation over a wide range of frequencies, in many different frequency bands.

Embodiments of the present device may be used for Multiple-Input-Multiple-Output (MIMO) applications, and also for diversity applications, where two or more signals in the same frequency band are distinguished by other characteristics such as polarization.

Polarization diversity, for example making use of phase shifts, for example 90 degree phase shifts, between certain matching circuits and/or signal ports, can be used to help improve isolation between signal ports.

The reconfigurable antenna device disclosed herein may be configured in a number of different ways depending on the requirements of a manufacturer of portable radio devices.

The antenna device may further comprise a control system which is connected to each signal port and which comprises a control means for selecting a desired operating mode.

In one embodiment, the first unbalanced antenna may be configured, with appropriate matching circuitry, as an LTE chassis antenna. The first balanced antenna may be configured as a low band LTE antenna. The fourth and fifth unbalanced antennas may be configured for WFi (low and high band) and GPS operation. The second and third unbalanced antennas may be configured for WiFi (low and high band) and GPS operation. The second and third balanced antennas may be configured for mid and high band LTE operation.

By providing a degree of antenna redundancy around the periphery, present embodiments may address the problem of a user holding the handset in different ways. For example, when the handset is held at the bottom, then the antennas at the top of the handset will work. When the handset is held at the top, then the antennas at the bottom of the handset will work. When the handset is held in a landscape position, the user's hands might cover the top left and bottom left corners of the periphery, in which case the antennas at the top right and bottom right corners will work. Likewise, when the handset is held with the user's hands covering the top right and bottom right corners, then the antennas at the top left and bottom left corners will work. If the antennas on the left hand side are covered by the user's hand, then the antennas on the right hand side will work, and vice versa.

### BRIEF DESCRIPTION OF THE DRAWINGS

Embodiments of the invention are further described hereinafter with reference to the accompanying drawings, in which:

FIG. 1 shows a first embodiment in schematic form;

FIG. 2 shows a close up of the top of the embodiment of FIG. 1;

FIG. 3 is a plot showing the return loss of the embodiment of FIG. 1;

FIG. 4 shows a second embodiment in schematic form;

FIG. 5 is a plot showing the return loss of the embodiment of FIG. 4;

FIG. 6 shows a third embodiment in schematic form;

FIG. 7 shows a system block illustrating how the embodiment of FIG. 6 may be used to drive 13 ports; and

FIG. 8 is a plot showing the return loss of the embodiment of FIG. 6.

### DETAILED DESCRIPTION

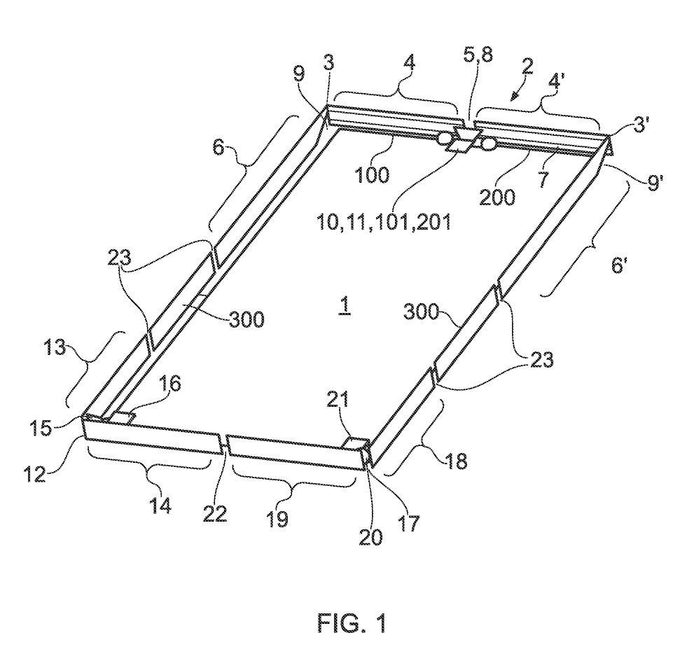

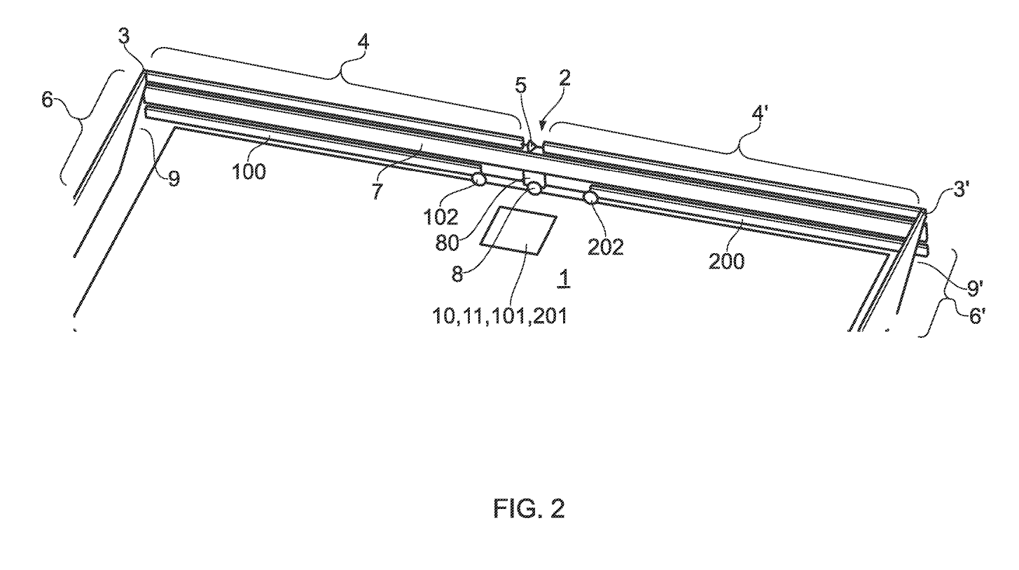

A first embodiment is shown in FIGS. 1 and 2. There is provided a substrate 1, which may be a PCB of a mobile telephone handset, the substrate 1 including a conductive groundplane over a majority of its area. The antenna device forms a generally rectangular frame around the substrate 1, and may be incorporated into a casing (not shown) of the mobile handset (not shown), for example as a bezel or the like. Alternatively, the antenna device may be mounted to an interior surface of the casing of the mobile handset, as required by design and aesthetic considerations.

The antenna device of this embodiment comprises six distinct antennas, each of which is provided with a matching circuit connected to a signal port, the matching circuits and signal ports being mounted on the substrate 1.

A first balanced antenna 2 is provided at the top edge of the substrate 1, and comprises first and second radiating arms 3, 3′. Each radiating arm 3, 3′ has a proximal portion 4, 4′ extending parallel to the top edge of the substrate 1 away from a central feed point 5, and a distal portion 6, 6′ extending part way along and parallel to the left and right sides respectively of the substrate 1.

A first unbalanced antenna 7 is also provided at the top edge of the substrate 1, extending parallel to the proximal portions 4, 4′ of first balanced antenna 2. In the embodiment of FIG. 1, the first unbalanced antenna 7 is located on the side of the first balanced antenna 2 that faces towards the substrate 1 and spaced a small distance therefrom. The first unbalanced antenna 7 has a central feed point 8, which may take the form of a central stub 80 extending from the first unbalanced antenna 7. It can be seen that the first unbalanced antenna 7 is located between the distal portions 6, 6′ of the first balanced antenna 2. A notch or cut-out 9, 9′ is provided at the end of each distal portion 6, 6′ of the first balanced antenna 2 where it meets the proximal portion 4, 4′. The notches or cut-outs 9, 9′ expose the ends of the first unbalanced antenna 7 at the top left and top right corners of the frame. The notches 9, 9′ may help to reduce unwanted coupling between the antennas 2, 7.

Second and third unbalanced antennas 100, 200 (best seen in FIG. 2) are provided at the top edge of the substrate 1, respectively extending parallel to the proximal portions 4, 4′ of the first balanced antenna 2. The second and third unbalanced antennas 100, 200 are each provided with a feed 102, 202.

Each of the first balanced antenna 2 and first to third unbalanced antennas 7, 100, 200 is provided with a respective matching circuit and signal port 10, 11, 101, 201 on the substrate 1.

A second balanced antenna 12 is provided at the bottom left corner of the substrate 1. The second balanced antenna 12 is configured as a dipole and comprises a first radiating arm 13 extending up the left side of the substrate 1 and a second radiating arm 14 extending along the bottom edge of the substrate 1 at a right angle to the first radiating arm 13. The second balanced antenna 12 is fed at a feed point 15 between the first 13 and second 14 radiating arms. A matching circuit and signal port 16 is provided on the bottom left corner of the substrate 1.

A third balanced antenna 17 is provided at the bottom right corner of the substrate 1. The third balanced antenna 17 is configured as a dipole and comprises a first radiating arm 18 extending up the right side of the substrate 1 and a second radiating arm 19 extending along the bottom edge of the substrate 1 at a right angle to the first radiating arm 18. The second balanced antenna 17 is fed at a feed point 20 between the first 18 and second 19 radiating arms. A matching circuit and signal port 21 is provided on the bottom right corner of the substrate 1.

The ends of the second radiating arms 14, 19 are separated from each other at the bottom edge of the substrate 1 by an air gap 22, or alternatively by a solid dielectric spacer.

The ends of the first radiating arms 13, 18 of the second and third balanced antennas 12, 17 in this embodiment are separated from the ends of the distal portions 6, 6′ of the first balanced antenna 2 at the left and right edges of the substrate 1 by air gaps/dielectric spacers 23. Additional metal or non-metal spacers 300 may be provided as required, the spacers 300 optionally helping to reduce unwanted coupling.

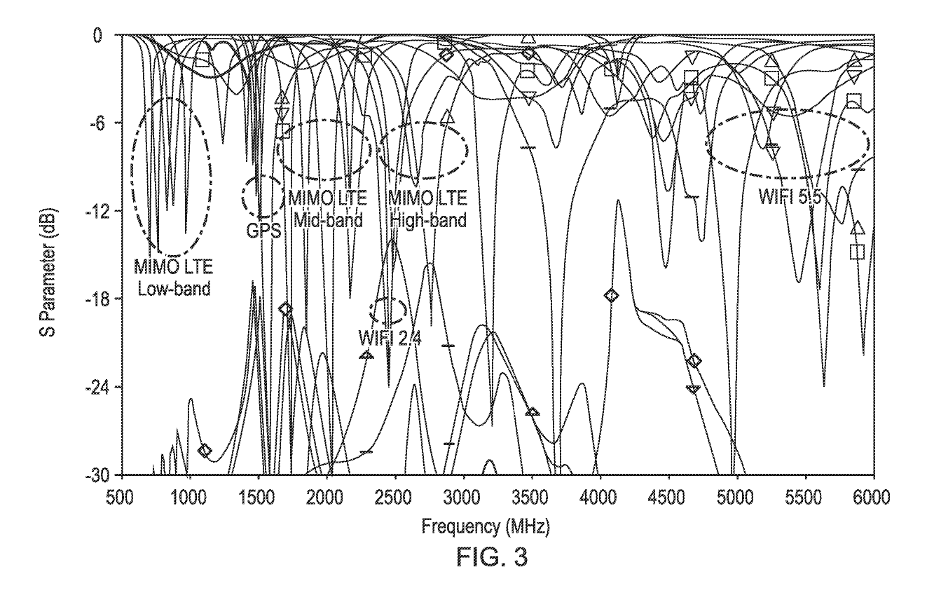

The return loss for the antenna device of FIGS. 1 and 2 is shown FIG. 3, demonstrating that the antenna device can operate in six frequency bands (MIMO LTE low-band, GPS, MIMO LTE mid-band, 2.4 GHz WiFi, MIMO LTE high-band and 5.5 GHz WiFi). Isolation at 700 MHz is below −30 dB, and at 2700 MHz is below −15 dB.

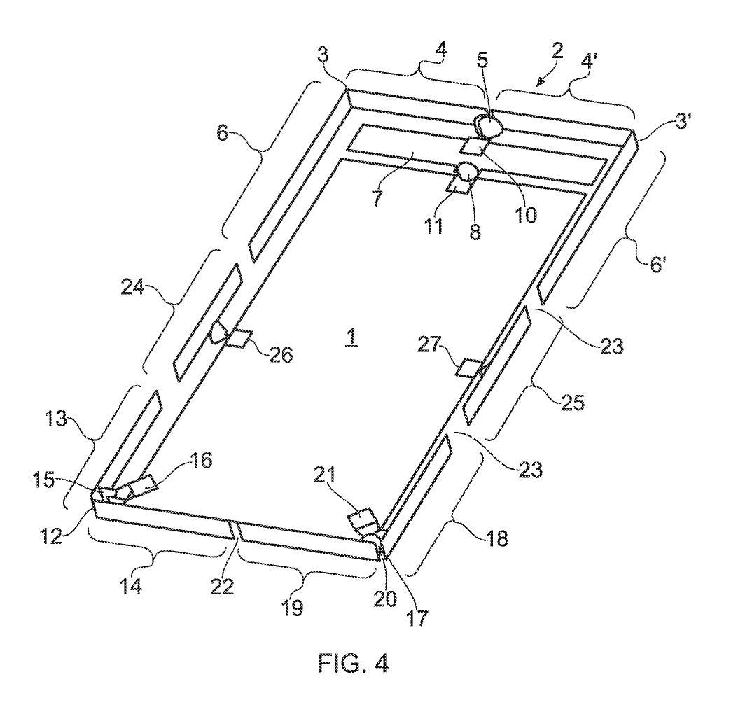

FIG. 4 shows a second embodiment, with the various components labelled as in FIG. 1. In this embodiment, the first unbalanced antenna 7 is disposed in the same plane as the substrate 1, or in a parallel plane. The first unbalanced antenna 7 may be mounted directly on a groundplane-free region at the top edge of the substrate 1, or may be formed as a separate element above the top edge of the substrate 1 as shown in FIG. 3. The matching circuit and signal port 10 for the first balanced antenna 2 may be mounted on a floating groundplane provided on a central part of the first unbalanced antenna 7.

The embodiment of FIG. 4 also includes a second unbalanced antenna 24 at the left side of the substrate 1 and a third unbalanced antenna 25 at the right side of the substrate 1. The second and third unbalanced antennas 24, 25 are respectively located between the ends of the first radiating arms 13, 18 of the second and third balanced antennas 12, 17 and the ends of the distal portions 6, 6′ of the first balanced antenna 2 at the left and right edges of the substrate 1. Air gaps/dielectric spacers 23 are provided to prevent conductive electrical contact. The second and third unbalanced antennas 24, 25 each have a feed point connected to a respective matching circuit and signal port 26, 27.

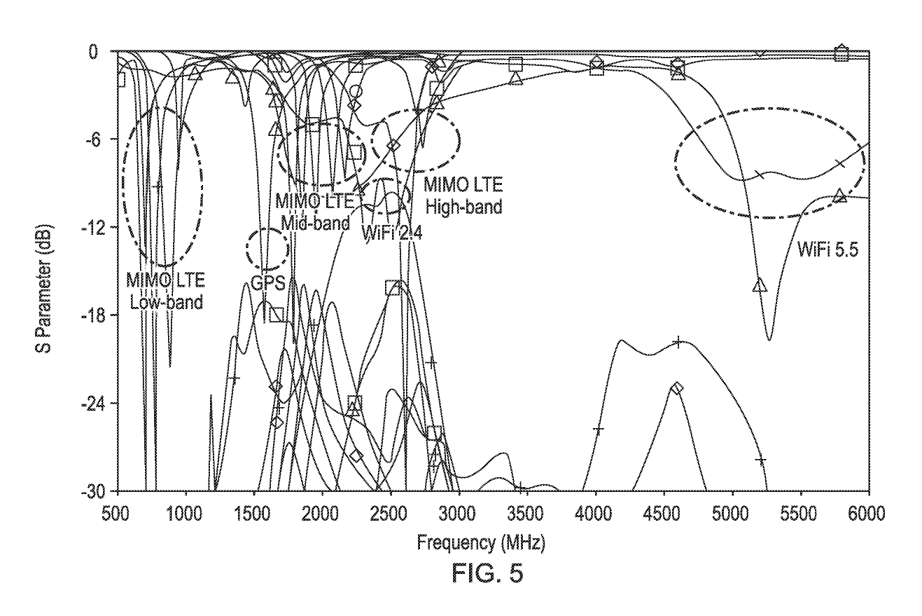

The return loss for the antenna device of FIG. 4 is shown FIG. 5, demonstrating that the antenna device can operate in six frequency bands (MIMO LTE low-band, GPS, MIMO LTE mid-band, 2.4 GHz WiFi, MIMO LTE high-band and 5.5 GHz WiFi). Isolation at 700 MHz is below −30 dB, and at 2700 MHz is below −10 dB.

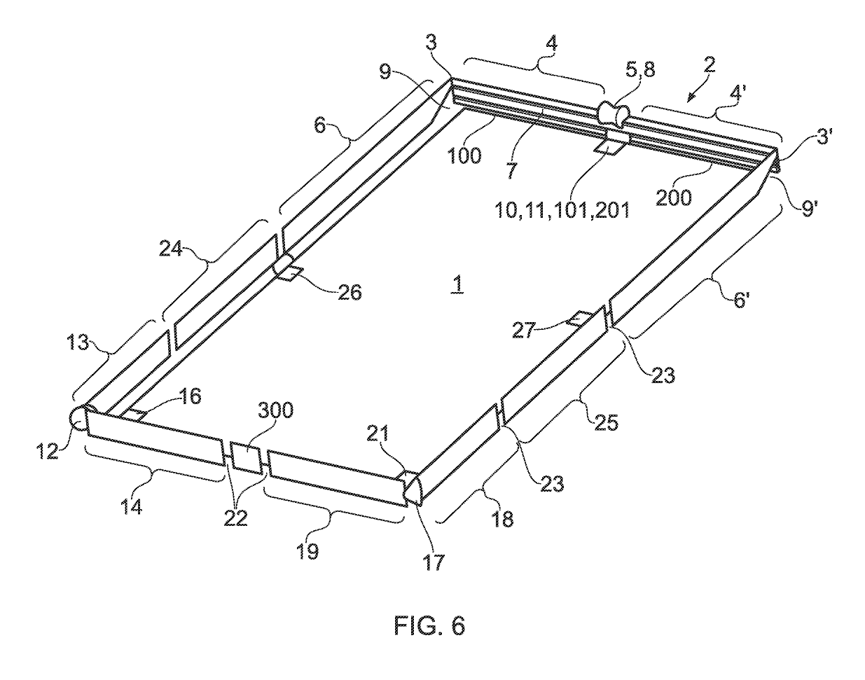

FIG. 6 shows a third embodiment, which is similar to that of FIG. 1, but includes the unbalanced antennas 24, 25 of the FIG. 4 embodiment as fourth and fifth unbalanced antennas in addition to the second and third unbalanced antennas 100, 200. The embodiment of FIG. 6 thus has three balanced antennas 2, 12, 17 and five unbalanced antennas 7, 100, 200, 24, 25 distributed around the periphery. An additional metal or non-metal spacer 300 may be provided on the bottom edge for cosmetic reasons and optionally to help reduce unwanted coupling between balanced antennas 12 and 17.

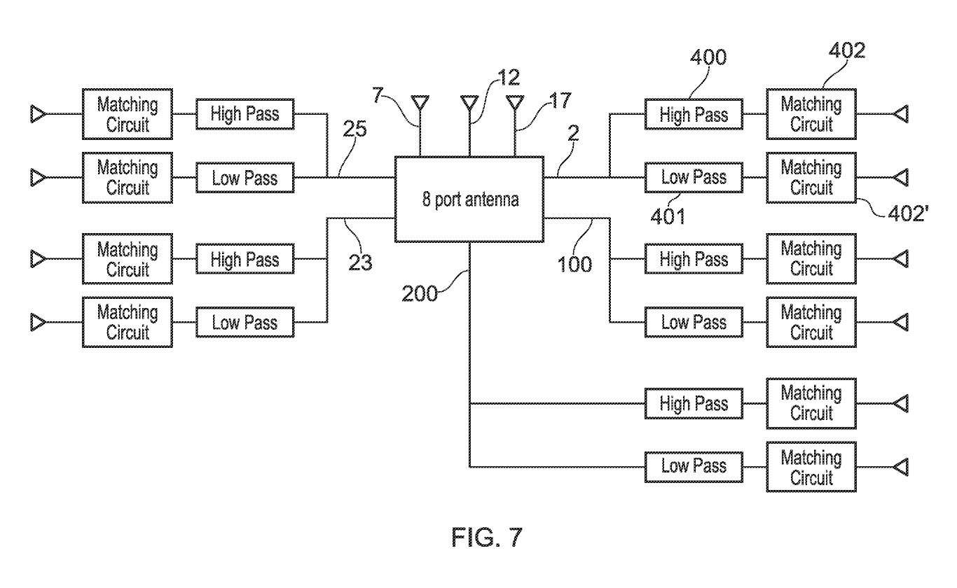

FIG. 7 is a system block showing how the antenna device of the FIG. 6 embodiment, comprising eight separate antennas, can be provided with suitable matching circuitry to drive 13 signal ports. Using high pass and low pass filters 400, 401 and matching circuits 402, 402′, it is possible for a single antenna element to handle two independently tuneable RF signals, as described in more detail in the present Applicant's co-pending UK patent application no GB1415780.4.

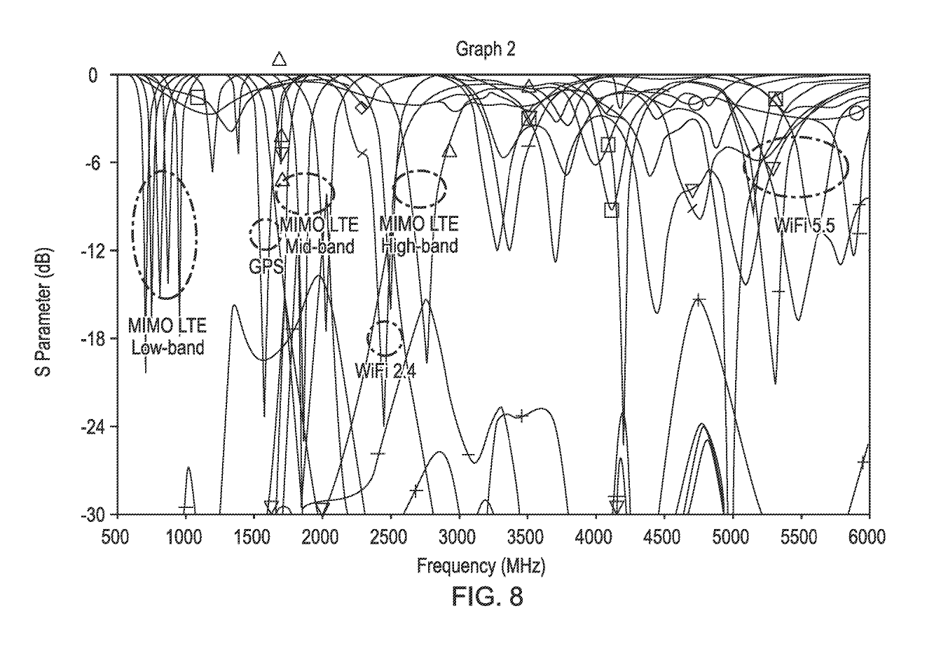

The return loss for the antenna device of FIGS. 6 and 7 is shown FIG. 8, demonstrating that the antenna device can operate in six frequency bands (MIMO LTE low-band, GPS, MIMO LTE mid-band, 2.4 GHz WiFi, MIMO LTE high-band and 5.5 GHz WiFi).

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A reconfigurable antenna device comprising a plurality of antennas disposed about a periphery of a substantially rectangular shape having top, bottom, left and right sides, the antennas comprising:
i) a first balanced antenna having first and second radiating arms each having a proximal portion and a distal portion, proximal portions extending along the top side in respectively opposed directions from a substantially central feed point, and the distal portions extending part way down the left and right sides;
ii) a first unbalanced antenna located generally between the distal portions and adjacent to the proximal portions of the first and second radiating arms;
iii) a second balanced antenna having a first radiating arm extending up the left side from a feed point in a bottom left corner of the periphery and a second radiating arm extending along the bottom side from the feed point in the bottom left corner of the periphery; and
iv) a third balanced antenna having a first radiating arm extending up the right side from a feed point in a bottom right corner of the periphery and a second radiating arm extending along the bottom side from the feed point in the bottom right corner of the periphery.

2. A device as claimed in claim 1, further comprising a second unbalanced antenna located on the left side between the distal portion of the first radiating arm of the first balanced antenna and the first radiating arm of the second balanced antenna, the second unbalanced antenna having a feed point.

3. A device as claimed in claim 1, further comprising a third unbalanced antenna located on the right side between the distal portion of the second radiating arm of the first balanced antenna and the first radiating arm of the third balanced antenna, the third unbalanced antenna having a feed point.

4. A device as claimed in claim 1, further comprising a fourth unbalanced antenna located along the top side adjacent and substantially parallel to the proximal portion of the first radiating arm of the first balanced antenna.

5. A device as claimed in claim 1, further comprising a fifth unbalanced antenna located along the top side adjacent and substantially parallel to the proximal portion of the second radiating arm of the first balanced antenna.

6. A device as claimed in claim 1, wherein the proximal and distal portions of each radiating arm of the first balanced antenna are disposed substantially at right angles to each other.

7. A device as claimed in claim 1, wherein the first and second radiating arms of each of the second and third balanced antennas are disposed substantially at right angles to each other.

8. A device as claimed in claim 1, configured as a part of a casing or bezel of a mobile phone handset, tablet or laptop computer.

9. A device as claimed in claim 1, further comprising a substrate including a conductive groundplane.

10. A device as claimed in claim 1, wherein the antennas comprise elongate conductive metal strips that are arranged around the periphery.

11. A device as claimed in claim 10, wherein the strips each have a width that is disposed substantially perpendicular to the plane of the substrate.

12. A device as claimed in claim 10, wherein the first unbalanced antenna comprises an elongate metal strip that is disposed in the same plane as or parallel to the substrate at a top edge thereof, adjacent to the proximal portions of the radiating arms of the first balanced antenna and between the distal portions of the radiating arms.

13. A device as claimed in claim 12, wherein the first unbalanced antenna is mounted flat on a surface of the top edge of the substrate, this part of the substrate being free of the conductive groundplane.

14. A device as claimed in claim 13, wherein a floating groundplane in the form of a conductive patch is provided over or under a central portion of the first unbalanced antenna, and a matching circuit for the first balanced antenna is located on the floating groundplane.

15. A device as claimed in claim 1, wherein the feed point of each antenna is connected via a respective matching circuit to at least one respective signal port.

16. A device as claimed in claim 1, wherein the first, second and/or third balanced antennas are configured as dipole antennas.

17. A device as claimed in claim 1, wherein the first, second and/or third balanced antennas are configured as centre feed slot antennas.

18. A device as claimed in claim 1, wherein the first, second, third, fourth and/or fifth balanced antennas are configured as offset feed slot antennas.

19. A device as claimed in claim 1, wherein ends of the radiating arms of the antennas are spaced from each other around the periphery by air gaps or solid dielectric spacer elements.

20. A device as claimed in claim 1, wherein at least some of the antennas are wholly or partially provided with a dielectric coating.

21. A device as claimed in claim 1, wherein the antennas are wholly or partially provided with a dielectric coating.

22. (canceled)
